(19) United States
(12) Patent Application Publication
(10) Pub. No.: US 2026/0200356 A1
(43) Pub. Date: Jul. 16, 2026

(54) METHOD AND SCHEDULING SYSTEM FOR GENERATING A DRIVING SCHEDULE FOR A BATTERY ELECTRIC MINING VEHICLE

(71) Applicant: ABB Schweiz AG, Baden (CH)

(72) Inventors: Rickard Lindkvist, Västerås (SE); Max Astrand, Umeå (SE); Lisa Onnerlov, Skelleftea (SE)

(21) Appl. No.: 19/135,475

(22) PCT Filed: Dec. 6, 2022
(86) PCT No.: PCT/EP2022/084602

§ 371 Date: Jun. 4, 2025

(51) Int. Cl. B60L 53/30; B60L 7/10; B60L 53/62; G01C 21/34

(52) U.S. Cl. CPC B60L 53/32; B60L 7/10; B60L 53/305; B60L 53/62; G01C 21/343; G01C 21/3469; G01C 21/3476; G01C 21/3484; B60L 2200/40; B60L 2240/12; B60L 2260/54; B60L 2260/58

(57) ABSTRACT

A method of generating a driving schedule for a battery electric mining vehicle, is described. The method generally includes obtaining a current state of charge of the vehicle, and obtaining a target path of the vehicle. The target path includes a charging section provided in a section of the target path. The charging section has a charging infrastructure for providing a charging power to the vehicle. The target path further includes a road section suitable for regenerating electrical energy with the vehicle. Based on target path data and the current state of charge of the vehicle, a driving schedule is generated including instructions to control a movement of the vehicle along the target path. Generating the driving schedule includes optimizing the driving schedule according to penalties. The penalties include a penalty term indicative of an amount of energy wasted when the vehicle travels along the road section.

### CROSS REFERENCE TO RELATED APPLICATION

The present application is a national phase entry of International Patent Application No. PCT/EP 2022/084602, filed on Dec. 6, 2022, and titled “METHOD AND SCHEDULING SYSTEM FOR GENERATING A DRIVING SCHEDULE FOR A BATTERY ELECTRIC MINING VEHICLE”, which is hereby incorporated by reference in their entirety.

### TECHNICAL FIELD

Aspects of the present disclosure relate to the operation of battery electric mining vehicles, in particular in the context of a mine. Aspects of the present disclosure particularly relate to generating an optimized driving schedule for minimizing an amount of wasted energy.

### BACKGROUND

Mining vehicles often include electric traction motors, which may be powered by a diesel-electric drivetrain or even an external electrical power source, such as trolley lines.

Recent developments suggest including on-board batteries into mining vehicles, which may power the electric motor for extended periods, thus potentially further reducing the need for fossil fuels while the mining vehicle is operated in an area without an external electrical power source.

In many mining vehicles, the electric traction motor may be used as a brake. Advantageously, braking with the electric traction motor may reduce wear on mechanical brakes and the drivetrain. Furthermore, in battery-powered electric mining vehicles, the electrical energy regenerated during braking may even be utilized for charging an on-board battery. However, once the battery has been charged to a maximum state of charge or beyond a predetermined setpoint, the regenerated energy may be wasted, e.g. in a dump resistor.

Thus, there is a need for operating a battery electric mining vehicle so that the amount of wasted energy is minimized. The methods and systems described herein may solve the above-stated problem at least in part.

### BRIEF DESCRIPTION

According to an aspect, a method of generating a driving schedule for a battery electric mining vehicle is described. The method includes obtaining a current state of charge of the vehicle, and obtaining a target path of the vehicle. The target path includes a charging section provided in a section of the target path, the charging section having a charging infrastructure for providing a charging power to the vehicle, and a road section suitable for regenerating electrical energy with the vehicle. Based on target path data and the current state of charge of the vehicle, a driving schedule including instructions to control a movement of the vehicle along the target path is generated. Generating the driving schedule includes optimizing the driving schedule according to penalties. The penalties include a penalty term indicative of an amount of energy wasted when the vehicle travels along the road section.

According to an aspect, a scheduling system for generating a driving schedule for a battery electric mining vehicle is described. The scheduling system includes a communication device configured for receiving vehicle parameters indicative of a current state of charge of the vehicle, and a modeling engine. The scheduling system is configured for obtaining a target path of the vehicle. The target path includes a charging section suitable for providing a charging power to the vehicle, and a road section suitable for regenerating electrical energy with the vehicle. The modeling engine is configured for, based on target path data and vehicle parameters, generating a driving schedule including instructions to control a movement of the vehicle along the target path. Generating the driving schedule includes optimizing the driving schedule according to penalties, the penalties including a penalty term indicative of an amount of energy wasted when the vehicle travels along the road section.

According to an aspect, a mining vehicle is described. The mining vehicle may be, for example, a load, haul and dump (LHD) machine, a mining truck, a bolter, a driller and/or a pickup truck. Passenger vehicles, such as road cars, trains, aircraft or boats are not considered mining vehicles in the context of this disclosure. The mining vehicle may be a battery electric vehicle. Accordingly, the mining vehicle may include an on-board battery. The battery may essentially be the sole source of on-board traction power of the vehicle, or the battery may be provided in addition to a drivetrain including a combustion engine, such as in a diesel electric vehicle, particularly a hybrid diesel electric vehicle, and/or even an alternative power source, such as a fuel cell. The on-board battery may be a battery for powering the traction motor. The mining vehicle may be configured for being powered by the battery, such as by the battery alone, or by the battery in combination with a combustion engine, for a substantial section of an operation cycle, such as for at least a portion of a haul cycle, e.g. along an unpowered section of a path. Accordingly, a mining vehicle having a battery not suitable for powering the traction motor of the mining vehicle, such as, for example, a starter battery, is not considered a battery electric mining vehicle in the context of this disclosure. According to an aspect, the mining vehicle may be controlled by an operator, such as a driver. Additionally, or alternatively, the mining vehicle may be remote controlled, semi-autonomous or even fully autonomous and/or self-driving.

According to an aspect, the mining vehicle is operated in an industrial site and/or industrial structure, such as a mine, and/or in or in between an industrial site associated with a mine, such as a processing plant, a logistics installation, a shipping yard or the like. The industrial structure will herein be referred to as a mine. The mine may have a layout, such one or more pathways and/or roads, particularly a network of roads. The mining vehicle may operate along paths on the network. During operation, a vehicle may travel along a target path, e.g. to perform a task, such as hauling material from a first location to a second location.

According to an aspect, the mine may include at least one road section suitable for regenerating electrical energy with the vehicle (“road section”). Generally, any type of road section may be suitable for braking, allowing the mining vehicle to regenerate electrical energy. For example, the road section may be a section along a pathway with an inclination, such as a ramp section. When travelling downhill along the ramp section, the mining vehicle may utilize the traction motor for braking and generate an electrical power with the traction motor. For example, a portion of the road proximate an intersection, at which the mining vehicle may be required to brake due to traffic rules, may be considered a road section.

According to an aspect, the electrical power may be available for recharging the battery of the mining vehicle, or be otherwise utilized, e.g. for heating components of the mining vehicle, such as the cabin or the battery, or even the surroundings of the mining vehicle. Electrical power which may not be utilized may be dissipated, e.g. as heat, by a dumping resistor in the mining vehicle. Unutilized electrical power may be considered wasted power in the context of this disclosure.

According to an aspect, a driving schedule is described. A driving schedule may include one or more instructions to control a movement of the mining vehicle. In particular, the driving schedule may include one or more instructions to control a movement of the mining vehicle along the target path, such as in a section of the target path, such as a charging section, an unpowered section, and/or a road section suitable for regenerating electrical energy with the vehicle. The driving schedule may include instructions for controlling a speed of the vehicle along the target path, particularly along positions and/or sections of the target path. For example, the driving schedule may include instructions that, when followed by the vehicle, cause the vehicle to remain in a section of the target path for a predefined amount of time. Accordingly, a speed of the vehicle may be understood as a rate of movement, such as a distance travelled within a timespan, and/or a desired time interval to be spent by the vehicle in a section of the target path. In particular, the speed of the vehicle, as defined by the driving schedule, may not necessarily be a constant speed. For example, the driving instructions may define a speed of the vehicle as remaining inside a charging section for a predefined amount of time, and/or leave the charging section at a predefined timepoint or after a predefined timespan following the entry of the charging section has expired. Accordingly, a speed of the vehicle inside e.g. a charging section may be defined as the vehicle travelling at a defined rate of movement, and/or even remaining in a stationary position for a defined amount of time. For example, the driving schedule may include instructions for stopping the vehicle for a predefined amount of time within the charging section, e.g. for charging the vehicle while stationary.

An advantage of the present disclosure may include seamlessly integrating an optimized charging scheme into the production cycle. Beneficially, energy consumption due to wasting energy may be reduced. Additionally, a mining vehicle may be operated with reduced downtime, since less or even no time may be spent overcharging a vehicle with energy that would later be regenerable during production, e.g. in a stationary charger, or while traveling at reduced speed. Additionally, in some embodiments, the efficient operation of the vehicle in the production cycle may be considered during optimization of the driving schedule, which may offer the benefits described herein without reducing, or even improving the productivity of the mining vehicle in the production cycle.

Further advantages, features, aspects and details that can be combined with embodiments described herein are evident from the dependent claims, the description and the drawings.

### BRIEF DESCRIPTION OF DRAWINGS

The details will be described in the following with reference to the figures, wherein

FIG. 1 is a schematic view of a target path in a mine.

FIG. 2A is an exemplary graph demonstrating a state of charge of a mining vehicle while traveling along a target path according to a non-optimized driving schedule.

FIG. 2B is an exemplary graph demonstrating a state of charge of a mining vehicle while traveling along a target path according to an optimized driving schedule.

FIG. 3 shows a method of generating a driving schedule for a battery electric mining vehicle.

FIG. 4 schematically shows a scheduling system according to embodiments.

### DETAILED DESCRIPTION

Reference will now be made in detail to the various embodiments, one or more examples of which are illustrated in each figure. Each example is provided by way of explanation and is not meant as a limitation. For example, features illustrated or described as part of one embodiment can be used on or in conjunction with any other embodiment to yield yet a further embodiment. It is intended that the present disclosure includes such modifications and variations.

Within the following description of the drawings, the same reference numbers refer to the same or to similar components. Generally, only the differences with respect to the individual embodiments are described. Unless specified otherwise, the description of a part or aspect in one embodiment applies to a corresponding part or aspect in another embodiment as well.

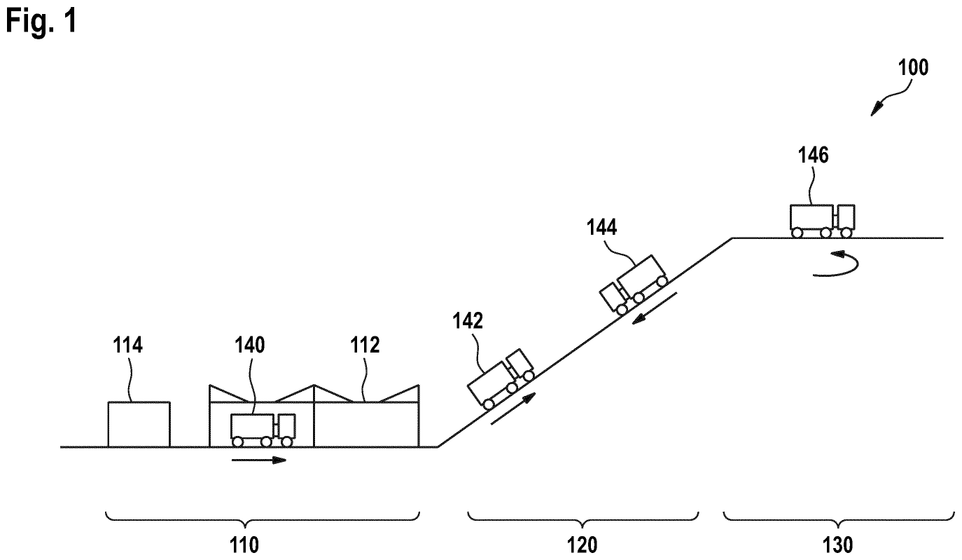

Referring now to FIG. 1, a schematic target path 100 is described. The target path 100 may be a representation of a pathway, such one or more roads in a road network, to be travelled along by a battery electric mining vehicle 140 in a mine, e.g. to fulfil a certain production goal and/or haul plan, such as hauling material from a first location to a second location. The target path 100 includes a charging section 110, a ramp section 120 which may be both a road section and an unpowered section, and an unpowered section 130.

The charging section 110 incudes a trolley line 112. While traveling along the trolley line 112, the mining vehicle 140 may be electrically connected, e.g. via a pantograph-style connector, to the trolley line and receive electrical energy from the trolley line 112 for powering the traction motor and/or charging an on-board battery of the mining vehicle 140. Additionally, or even alternatively, the charging section may include a charging station 114, in which the battery of the mining vehicle may be charged while the mining vehicle 140 is stationary, e.g. via a plug-type connector. In the context of this disclosure, a charging section should be considered any section along the target path in which the mining vehicle may receive electrical power provided by a charging infrastructure. Accordingly, different types of charging infrastructure may be provided, such as catenary lines and/or overhead lines, powered rails, inductive power transfer systems, or other known technologies.

As shown in FIG. 1, the target path includes an unpowered section 130. In the unpowered section 130, the mining vehicle 146 is operated under its own power, particularly from power provided by the on-board battery. Accordingly, while traveling in the unpowered section, the state of charge (SOC) of the on-board battery may reduce. The mining vehicle 146 is in an unpowered section 130. Likewise, the mining vehicle 142, while going up the ramp in section 120, is operated under its own power, and thus in an unpowered section.

As shown in FIG. 1, the mining vehicle 144 is travelling downhill a ramp in section 120. While travelling, the mining vehicle 144 utilizes a traction motor to brake and generate an electrical power. The mining vehicle 144 does not operate under its own power, i.e. power from the on-board battery, and instead has a power surplus which may be utilized for charging the on-board battery. Accordingly, while going downhill the ramp section 120, the mining vehicle 144 is in a road section suitable for regenerating electrical energy with the vehicle 144.

The target path 100 shown in FIG. 1 is a simplified example intended to better help understand the present disclosure and the underlying problem. According to embodiments, various modifications are possible. As shown in FIG. 1, the charging section 110 may be provided in an essentially flat section of the target path 100. Likewise, the charging section 110 may also be provided in a portion of the road having an inclination, such as along a ramp in section 120, particularly for vehicles travelling uphill along the ramp. A target path may include several waypoints and be more complex than shown in FIG. 1, for example, a target path may include different variations and/or combinations of the charging sections, unpowered sections and road sections shown in FIG. 1, and may even include a multitude of sections.

According to embodiments, while the different section types shown in FIG. 1 have been explained in the context of static and/or physical features of a pathway such as a road, it should be noted that these sections may be definable dynamically. For example, a fully loaded truck travelling at high speed along an essentially flat road may generate a road section by braking, while the same section remains an unpowered section 130 for a truck travelling at constant speed.

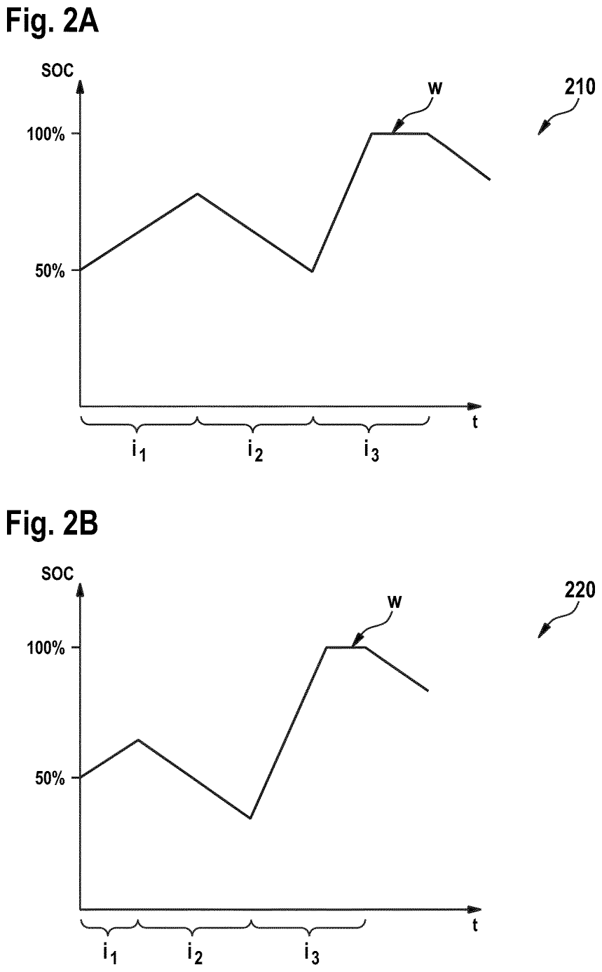

Referring now to FIG. 2A and FIG. 2B, an exemplary graph 210, 220 demonstrating a state of charge, SOC, of a mining vehicle over time t, such as the mining vehicle 140 shown in FIG. 1, while traveling along a target path is shown. The target path may be a target path 100 as shown in FIG. 1.

During the interval i₁, the mining vehicle is in a charging section, e.g. the vehicle may be travelling in a charging section, e.g. along a trolley line. In the example, while in the charging section, an on-board battery of the mining vehicle is charged.

It should be noted that in the examples shown in FIG. 2A and FIG. 2B, the vehicle has a SOC of 50% when beginning interval i₁. This SOC may have been reached by first charging the mining vehicle, e.g. in a charging station such as a charging station 114, by regenerating energy in a road section, and/or by operating the mining vehicle in an unpowered section from a higher SOC before entering the charging section.

It should be noted that the interval in shown in graph 210 is longer than the interval in shown in graph 220. Accordingly, a higher SOC is reached by the mining vehicle having the longer interval i₁. The interval 210 may be longer because the vehicle spent more time in the charging section, e.g. due to having a lower speed, than in the graph 220. Accordingly, a state of charge of the vehicle after leaving the charging section may be controllable by a speed of the vehicle within the charging section, e.g. by instructing the vehicle to operate at a certain speed while in the charging section, according to aspects and/or embodiments described herein.

Interval i₂ represents a time during which the mining vehicle has left the charging section and travels along an unpowered section, partially depleting the batterie's SOC by powering the traction motor. The power utilized by the mining vehicles in graph 210 and graph 220 is the same.

Following interval i₂, the mining vehicle enters a road section suitable for regenerating electrical energy with the vehicle, and uses the electrical energy in interval i₃ for charging the on-board battery. For example, but not limited thereto, a mining truck that was loaded with material at a high altitude and then transports the material downhill utilizing the traction motor as a brake may regenerate a larger amount of electrical energy than was utilized to drive the empty truck uphill. As can be seen by a comparison between graph 210 and graph 220, while in both examples, a full state of charge is reached, as shown by the plateau w, less regenerated energy is utilized for charging the on-board battery in the example shown in graph 210, due to the battery having a higher SOC when beginning the interval i₃. Since the energy may not be utilizable differently, the energy may be wasted.

It is an object of the present disclosure to provide a driving schedule including instructions to control a movement of the mining vehicle along the target path to minimize the amount of energy wasted, as shown in the examples given in FIG. 2A and FIG. 2B.

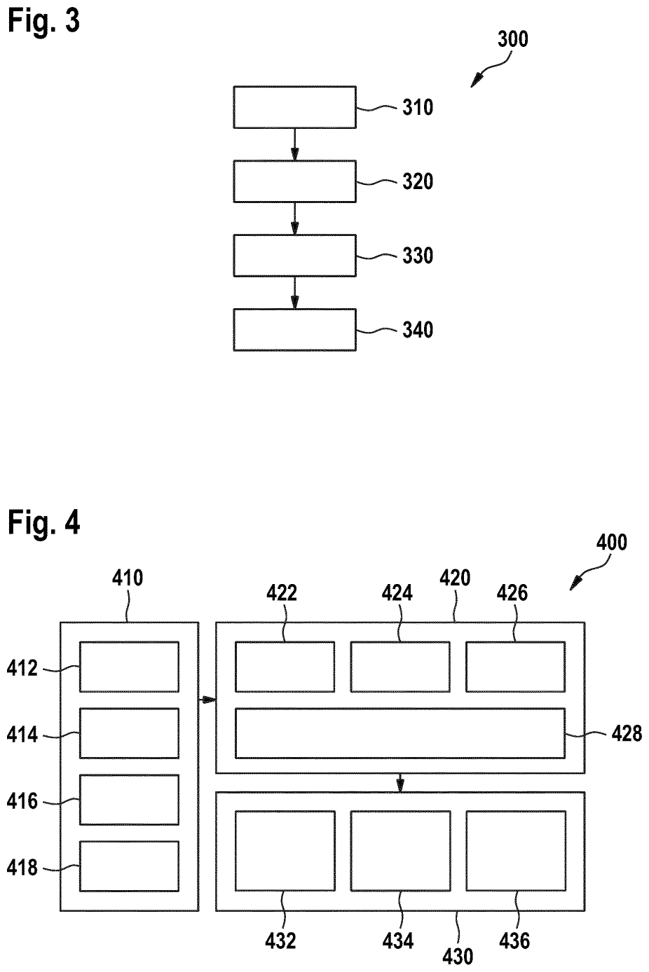

Referring now to FIG. 3, a method 300 of generating a driving schedule for a battery electric mining vehicle according to embodiments is described. It should be noted that the operations of the method 300 are described sequentially, however, at least some of the operations may be performed in parallel or, provided that the information and/or data utilized in one of the operations is already available, may even be skipped. In operation 310, a current state of charge of the vehicle is obtained, e.g. by measuring the state of charge of an on-board battery according to methods known in the art. Obtaining the state of charge of the battery may include communicating the obtained state of charge to e.g. a scheduling system. The current state of charge may be a vehicle parameter.

According to embodiments, in operation 310, additional vehicle parameters may be obtained. Vehicle parameters may include one or more of static vehicle parameters, dynamic vehicle parameters, vehicle constraints and/or schedule constraints.

According to embodiments, static vehicle parameters may include vehicle parameters that are essentially static for the vehicle, such as information about a make and/or model of the vehicle, a vehicle ID, information specific to the vehicle, such as weight of the vehicle, rated engine power, rated battery capacity, average and/or expected energy consumption, maintenance information, load capacity, or the like.

According to embodiments, dynamic vehicle parameters may include vehicle parameters that may change during the operation of the vehicle, such as the current load of the vehicle, data indicative of a power consumption during e.g. past operation cycles, data indicative of a state of the battery, such as battery deterioration, battery temperature, maximum battery charging rate, data indicative of future maintenance requirements, data indicative of the current status of the vehicle, or the like.

According to embodiments, vehicle constraints may include data indicative of performance limits of the vehicle, such as a maximum speed of the vehicle, which may be associated with a current load of the vehicle and/or target path data, such as a maximum allowed speed in a section of the target path, e.g. an uphill section, maximum load, maximum power draw, expected energy consumption along a section of the target path, or the like.

According to embodiments, schedule constraints may include data indicative of constraints associated with a schedule of the vehicle, such as scheduled breaks and/or shift end times, expected maintenance intervals, scheduled cooldown periods, or the like.

Operation 320 includes obtaining a target path of the vehicle. The target path may, for example, be a haul plan for the vehicle, such as a haul plan defining that a mining truck should haul material from a first location to a second location, the target path connecting the first location and the second location.

According to embodiments, obtaining the target path may include generating the target path, e.g. according to known route-planning methods, which may include optimizing the route according to embodiments described herein. The planned route defining the target path may be included in the driving schedule. Accordingly, operation 320 may include obtaining data indicative of a layout of the mine, particularly the pathways and/or roads of the mine.

The target path includes a charging section, such as a charging section 110 described with reference to FIG. 1, provided in a section of the target path, having a charging infrastructure for providing a charging power to the vehicle. The target path further includes a road section suitable for regenerating electrical energy with the vehicle. The target path may further include unpowered sections, such as sections in which the vehicle is operated under battery power. In an operation cycle, the unpowered section may be in-between a charging section and a road section.

According to embodiments, obtaining the target path in operation 320 may include obtaining target path data. Obtaining the target path data may include generating, at least in part, the target path data, e.g. based on a model of the mine, such as a computer-implemented physical model, such as a physics model, of the mine. According to embodiments, the model of the mine may essentially be represented as a 3D model. According to some embodiments, the model of the mine may be represented as a graph-based model, the model including e.g. paths as links, and intersections between the paths as nodes. The model may represent a path layout of the industrial site. Attributes of the paths and/or intersections, such as data suitable for simulating a mining vehicle traveling along the paths, may be stored in the model. Target path data may be derivable from the model and/or the attributes. For example, an attribute may include a road availability indicator indicating e.g. if a road is open or closed, e.g. due to obstructions. Obtaining the target path data may, additionally or alternatively, include utilizing historical data from previous, sometimes comparable trips and/or routes of the same or similar vehicles traveling along the target path under the same or similar conditions. Accordingly, particularly in cases where historical data is utilized, the obtaining of the target path data may be optional, and/or may be understood as retrieving the target path data, e.g. from a database. Alternatively, a target path may be obtained from an external source, e.g. from a routing system associated with the vehicle and/or the mine.

According to embodiments, the target path data may include data indicative of a target path layout, a power availability, and/or a power demand.

According to embodiments, the target path layout may include and/or correspond with a planned or plannable route. The target path layout may include additional information, such as data associated with a haul plan. For example, a path layout may be obtained based on a haul plan. For example, the path layout may include multiple possible routes, and allow the selection of one of a plurality of possible routes suitable for the haul plan as a target path.

According to embodiments, the target path data may include information about the power availability along a section of the target path. The power availability may be associated with the target path layout. The power availability may be indicative of a power that may be deliverable to a vehicle while the vehicle is in a charging section of the target path. The power availability may be dynamic. For example, a trolley line may be configured for providing a limited electrical power, and in situations where multiple vehicles are receiving power from the trolley line, the power available to a single vehicle may be lower than the limited electrical power providable by the trolley line. The power availability may further be indicative of a power that may be regeneratable by a vehicle while the vehicle is in a road section suitable for regenerating electrical energy with the vehicle. The power availability may depend on and/or be derivable from vehicle parameters, such as static vehicle parameters and/or dynamic vehicle parameters. Likewise, the power availability may be derivable from historical data.

According to embodiments, the target path data may include information indicative of a power demand along a section of the target path. The power demand may be derived from vehicle parameters of one or more vehicles scheduled to drive along the section of the target path. The power demand information may, for example, be obtained from historical data, and/or may be obtained based on a model, such as a physics model, utilizing vehicle parameters. The power demand may be indicative of an expected power draw of the one or more vehicles along a section of the target path, particularly a charging section. For example, an expected power demand exceeding the power availability may be undesirable, and be penalized accordingly during optimization of a driving schedule.

In operation 330, a driving schedule is generated. The driving schedule is generated based on target path data and the current state of charge of the vehicle. The driving schedule includes instructions to control a movement of the vehicle along the target path. The driving schedule may further be generated based on the vehicle parameters obtained in operation 310, and/or the target path parameters obtained in operation 320.

Generating the driving schedule includes optimizing the driving schedule according to penalties. The penalties include a penalty term indicative of an amount of energy wasted when the vehicle travels along the road section. As shown in FIG. 2A and FIG. 2B, energy may particularly be wasted when the energy regenerated in the road section exceeds the energy that may be stored in an on-board battery, and/or if the regenerated power exceeds a power that may be utilized for charging the on-board battery. Accordingly, as shown in FIG. 2A and FIG. 2B, the driving schedule may include instructions that control the length of the interval in shown in FIG. 2A and FIG. 2B. Accordingly, the driving schedule may include instructions that define the speed of the vehicle and/or the duration the vehicle remains in the charging section.

According to embodiments, the penalties include a penalty term indicative of an energy demand of the vehicle when traveling along the target path, such as an unpowered section. The penalty term may, for example, penalize optimizations resulting in the energy demand of the vehicle not being met, and may even penalize optimizations resulting in the state of charge of the vehicle, while exceeding the anticipated energy demand of the vehicle, being below a predefined safety margin.

According to embodiments, operation 330 may include estimating the energy demand of the vehicle along the target path. The estimation may be based on target path data, vehicle parameters, and/or the haul plan. The estimation may be based on modelling and/or historical data.

According to embodiments, optimizing the driving schedule may include defining a target charge of the vehicle when exiting the charging section, i.e. when the vehicle exits the charging section. The target charge may be a charge of the vehicle above a lower limit defined by an energy demand of the vehicle traveling along the target path after leaving the charging section and before entering the ramp section, such as an unpowered section. This may ensure that the vehicle does not receive an insufficient charge to travel in the unpowered section. The lower limit may be obtained e.g. from historical data and/or from a physics model. The lower limit may be derived from vehicle parameters and/or target path data.

The target charge may be a charge below an upper limit defined by the energy regeneratable in the road section. The upper limit may be a soft limit, and accordingly does not necessarily need to be chosen such that all the energy regeneratable in the road section may be fully utilized, e.g. for charging the on-board battery, i.e. in some cases, the upper limit may be below the lower limit. For example, an empty truck that is charged to the lower limit before going uphill may require a certain amount of energy to travel uphill. When loaded with material at the high-point, the heavier truck going downhill may regenerate more energy than may be storable in the battery. Accordingly, in some cases, the target charge may be above a lower limit, and in some further cases, which may be during optimization, the target charge may be between a lower limit and an upper limit.

According to embodiments, the method 300 may include operation 340. In operation 340, a driving schedule is generated according to aspects and/or embodiments described herein, and the mining vehicle is driven according to the driving schedule. Accordingly, the method 300 may be a method of controlling a battery electric mining vehicle in a mine.

According to embodiments, in operation 340, the driving schedule, and/or instructions included in the driving schedule, may be communicated to the vehicle and/or a driver of the vehicle. For example, a driver may receive the instructions, via a communication device, such as a smartphone, a tablet, a walkie-talkie, a drive assist system or even an autonomous driving system integrated into the vehicle, or the like. For example, the instructions may be signaled via a roadside signaling system, such as traffic lights or display boards. Communicating the instructions may cause the vehicle to remain within the charging section until the target state of charge is reached, e.g. by causing a driver to operate the vehicle according to the driving schedule. For example, instructions may include objectives, such as to drive the following charging section at a predefined speed while charging, or to stop, while connected to a charging infrastructure, e.g. at a predefined location, such as a charging spot with a stationary charger, or a parking location connected to a branched-off trolley line, until a predefined state of charge corresponding to the target charge has been reached.

According to embodiments, the method 300 may include considering production targets and/or production constraints. For example, it may, in some situations, be counterproductive to operate a mining vehicle according to a driving schedule that is optimized solely according to reducing wasted energy, particularly if the mining operation is negatively affected by such a driving schedule.

Accordingly, optimizing the driving schedule in operation 330 may include further penalties. The penalties may further include a penalty term indicative of production constraints. Production constraints may, for example, include time constraints. For example, a penalty based on a time constraint may result in a driving schedule that allows a higher amount of wasted energy than an optimal driving schedule, but cause the vehicle to arrive at a scheduled point in time that is within a time frame more beneficial for the production cycle. The penalties may further include a penalty term indicative of production targets. For example, a penalty based on a production target may allow overcharging an on-board battery to allow for repeated round-trips to avoid charging downtime between trips. For example, in a hybrid diesel-electric vehicle, a driving schedule may allow a portion of the unpowered section to be travelled under diesel power to reduce a time spent in the charging section, if the additional time results in a high penalty term based on production targets and/or production constraints.

According to embodiments, the method 300 may include generating an alternative target path for the vehicle. An alternative target path may be generated particularly if the driving schedule generated in operation 330 exceeds a predefined penalty threshold, i.e. if optimizing the driving schedule results in a driving schedule that is not feasible according to one or more of the penalties described herein, such as one or more of a penalty term indicative of an amount of energy wasted, a penalty term indicative of the energy demand of the vehicle, and/or a penalty term indicative of production constraints and/or production targets. The alternative target path may be generated as described for operation 320, and may be different than the previously obtained target path. For example, an alternative target path may be generated if a target charge is not obtainable with a driving schedule based on the previously obtained target path, or if the driving schedule does not satisfy a predefined production target or exceeds or violates a predefined production constraint. Likewise, an alternative target path may be generated if the energy wasted exceeds a predefined penalty threshold.

Referring now to FIG. 4, a schematic representation of a scheduling system 400 for generating a driving schedule for a battery electric mining vehicle is described. The scheduling system 400 may be configured for performing a method according to embodiments described herein, such as the method 300 described with reference to FIG. 3. The scheduling system may be implemented as a software, such as one or more programs to be executed by a computer system. The computer system may be communicatively connected to one or more mining vehicles, to send and receive data to and from the mining vehicles.

The scheduling system 400 includes a communication device 410 configured for receiving vehicle parameters indicative of a current state of charge of the vehicle. The vehicle parameters include a state of charge 412 of the vehicle. Further parameters receivable by the communication device 410 may include vehicle parameters 414, such as static vehicle parameters, dynamic vehicle parameters, vehicle constraints and/or schedule constraints. The communication device may be configured for receiving a haul plan 416. The haul plan 416 may be specific for the vehicle, and may include further data, such as a current location of the vehicle, a target location of the vehicle, a proposed route for the vehicle, or the like. The haul plan may include data indicative of a target path, or may even include a target path. Alternatively, or additionally, a target path may be generatable from the haul plan 416. The communication device may further be configured for receiving a mine layout 418. The mine layout 418 may not necessarily be received for every driving schedule to be generated, i.e. a model of the mine may be generated and stored in a memory of the scheduling system 400. The mine layout 418 may be receivable e.g. if changes in the mine layout occur, e.g. to update the model of the mine based on the mine layout 418. Furthermore, historical data about a trip, such a previous trip, of a mining vehicle along a path in the mine may be communicated and be utilized e.g. to build or refine a model of the mine.

The communication device 410 is configured for providing the vehicle parameters, particularly the state of charge of the vehicle, to the modelling engine 420. The modelling engine 420 may include a model 422 of the mine and/or the mining vehicle in the mine, particularly a physics model of the mine or a graph-based model of the mine suitable for simulating the mining vehicle travelling along paths in the mine, particularly a model configured for simulating and/or modelling a change in the state of charge of the mining vehicle when traveling along a path of the mine. The model may further include and/or be at least partially generated based on historical data, such as previous trips of mining vehicles.

The modelling engine 420 may include constraints 424. The constraints 424 may include and/or be derived from some or all of the constraints described herein. In particular, the constraints may be indicative of vehicle constraints, schedule constraints, target path data, and/or production constraints. The constraints may be utilizable by the modelling engine to generate a target path and/or a driving schedule that does not go beyond limitations defined by the constraints, such as physical limitations of the vehicle and/or the charging infrastructure, or virtual constraints, such as non-feasible driving schedules missing production goals.

The modelling engine 420 may include objectives 426. An objective may be reducing the amount of energy wasted when the vehicle travels along the road section. A further objective may be adhering to a production target, such as fulfilling a haul plan or any other production goal. The objectives 426 may be expressed as penalty terms. The objectives may be utilizable by the modelling engine to generate a target path and/or a driving schedule that has a low penalty score, the penalty score being derivable by simulating and/or modelling the vehicle travelling along the target path and calculating a penalty according to the penalty terms.

The modelling engine 420 may include an optimizer 428, such as an optimization routine. The optimizer 428 may be configured for optimizing variable parameters based on the data provided by the communication device 410 and/or the constraints 424 and objectives 426, such as a value indicative of a speed and/or time interval of the vehicle in a charging section, an unpowered section and/or a road section of the target path. In particular, the optimizer 428 may generate a plurality of potential driving schedules, and compare the potential driving schedules according to the objectives 426, e.g. by comparing the penalties associated with the potential driving schedule. Accordingly, the optimizer 428 may be configured for obtaining a penalty score by utilizing the model 422, e.g. for modelling and/or simulating the vehicle along the target path when driving according to the potential driving schedules. For example, the model 422 may allow estimating a state of charge of the vehicle after leaving the charging section, an energy demand of the vehicle while in an unpowered section, and an amount of energy recoverable in the road section. The optimizer 428 may be configured for selecting a driving schedule from the potential driving schedules based on the penalties associated with the driving schedules, i.e. select an optimized driving schedule.

According to embodiments, the modelling engine 420 may be implemented in commercially available simulation, planning, control, automation and/or modelling solutions, such as known solutions for optimizing industrial processes. Known solutions include, but are not limited to, the ABB Ability™ Expert Optimizer and related optimization-based functionalities, the ABB Ability™ Edgenius product family, the ABB Ability™ Operations Management System, and/or the ABB Ability™ System 800x A product family, as available at the time of filing of this disclosure.

According to embodiments, the scheduling system may generate a driving schedule 430. The driving schedule may be communicated to the mining vehicle, e.g. by the communication device 410. The driving schedule may be optimized for reducing an amount of energy wasted when the vehicle travels along the road section. The driving schedule 430 includes instructions 432 to control a movement of the vehicle along the target path, such as instructions described herein controlling a speed of the mining vehicle in a charging section, an unpowered section and/or a road section.

According to embodiments, the driving schedule may further comprise instructions 434 for controlling the charging of the on-board battery of the mining vehicle, particularly for controlling a charging rate, such as whether the on-board battery should be charged or not be charged. For example, if a state of charge of the vehicle is above a target state of charge, the driving schedule may be optimized by designating a (potential) charging section as an unpowered section, or even a section in which the traction motor should be powered by e.g. a trolley line, but no charging of the on-board battery should occur. Accordingly, for vehicles allowing a control of the charging, the driving schedule may include instructions to not charge the on-board battery while traveling through a (potential) charging section. Beneficially, the driving schedule, despite not including instructions to charge the vehicle in the charging section, may be optimized e.g. according to constraints 424 and objectives 426, and may e.g. prepare the truck for optimized charging in later stages of the target path. Accordingly, for vehicles including an additional power source for providing traction power, such as a diesel-electric drivetrain, the driving schedule may include instructions 434 for utilizing the additional power source to power the vehicle along at least a section of the target path, e.g. in cases where constraints and/or penalties result in the vehicle having an insufficient state of charge to fulfil the haul plan based on battery power alone.

According to embodiments, the driving schedule may include an estimation of the energy savings 436. The estimation may be based on the constraints 424 and/or objectives 426, and/or be generated by applying the optimizer 428 and/or modelling the plurality of vehicles in the modelling engine 420. The estimation of the energy savings 436 may beneficially allow reviewing the driving schedule, e.g. by a third party or even a driver of the vehicle.

According to embodiments, while the foregoing has been exemplary described in the context of controlling a speed of the vehicle in the charging section, the speed of the vehicle may further be controlled in the road section. In particular, a scheduling system or method as described herein may consider parameters of the on-board battery, such as battery state, battery temperature, battery deterioration, maximum battery charging rate and/or maximum battery discharging rate in applying constraints and/or penalty terms in generating the driving schedule for unpowered sections and/or even road sections. For example, a hot battery may only be chargeable at a low rate compared to a cold battery to prevent overheating. Accordingly, the driving schedule may include instructions to operate the vehicle at a comparably lower speed while in the road section, so that a lower power is generated while braking, which may be utilized for charging the battery instead of being (partially) wasted.

According to embodiments, an industrial site is described. The industrial site, particularly devices, sensors, a charging infrastructure, vehicles traveling within the industrial sites, production facilities associated with the industrial sites, and/or signaling devices may be communicatively connected to the scheduling system 400, particularly the communication device 410. The data, parameters, driving schedules, constraints and/or further types of data may be communicated through a communication system of the industrial site, such as a data network of the industrial site.

According to embodiments, the scheduling system 400, particularly the communication device 410, may comprise a network interface for connecting the device to a data network, in particular a global data network. The data network may be a TCP/IP network such as Internet. The scheduling system 400 is operatively connected to the network interface for carrying out commands received from the data network, and/or for sending commands to be carried out. The commands may include a control command for controlling the device to carry out a task such as generating a driving schedule 430. In this case, the scheduling system 400 is adapted for carrying out the task in response to the control command. The commands may include a status request. In response to the status request, or without prior status request, the scheduling system 400 may be adapted for sending a status information to the network interface, and the network interface is then adapted for sending the status information over the network. The commands may include an update command including update data. In this case, the scheduling system 400 is adapted for initiating an update in response to the update command and using the update data.

The data network may be an Ethernet network using TCP/IP such as LAN, WAN or Internet. The data network may comprise distributed storage units such as Cloud. Depending on the application, the Cloud can be in form of public, private, hybrid or community Cloud.

The disclosed systems and methods are not limited to the specific embodiments described herein. Rather, components of the systems or activities of the methods may be utilized independently and separately from other described components or activities.

This written description uses examples to disclose various embodiments, which include the best mode, to enable any person skilled in the art to practice those embodiments, including making and using any devices or systems and performing any incorporated methods. The patentable scope is defined by the claims and may include other examples that occur to those skilled in the art. Such other examples are intended to be within the scope of the claims if they have structural elements that do not differ from the literal language of the claims, or if they include equivalent structural elements with insubstantial differences form the literal language of the claims.

1. A method of generating a driving schedule for a battery electric mining vehicle, the method comprising:
obtaining a current state of charge of the vehicle;
obtaining a target path of the vehicle, the target path comprising:
a charging section provided in a section of the target path, the charging section having a charging infrastructure configured to provide a charging power to the vehicle; and
a road section suitable for the vehicle to regenerate electrical energy;
based on target path data and the current state of charge of the vehicle, generating the driving schedule comprising instructions to control a movement of the vehicle along the target path, wherein:
generating the driving schedule comprises optimizing the driving schedule according to penalties, and
the penalties comprise a penalty term indicative of an amount of energy wasted when the vehicle travels along the road section.

2. The method according to claim 1, wherein the penalties comprise a penalty term indicative of an energy demand of the vehicle when traveling along the target path.

3. The method according to claim 1, wherein:
optimizing the driving schedule comprises defining a target charge of the vehicle when exiting the charging section,
the target charge is a charge of the vehicle above a lower limit defined by an energy demand of the vehicle traveling along the target path after leaving the charging section and before entering the road section, and
the instructions cause the vehicle to remain within the charging section until the target state of charge is reached.

4. The method according to claim 1, wherein the charging section includes a trolley line configured to provide the charging power along a length of the target path.

5. The method according to claim 1, wherein the driving schedule includes instructions configured to control a speed of the vehicle along the target path.

6. The method according to claim 1, wherein the driving schedule includes instructions configured to stop the vehicle for a predefined amount of time within the charging section.

7. The method according to claim 1, wherein the target path data include one or more of:
a target path layout;
a power availability along a section of the target path; and/or
a power demand along a section of the target path.

8. The method according to claim 1, further comprising:
obtaining vehicle parameters; and
generating the driving schedule based on the vehicle parameters, wherein the vehicle parameters include one or more of:
static vehicle parameters;
dynamic vehicle parameters;
vehicle constraints; and/or
schedule constraints.

9. The method according to claim 7, wherein the target path data is generated from past trips along the target path.

10. The method according to claim 1, wherein the penalties comprise:
a penalty term indicative of production constraints; and/or
a penalty term indicative of production targets.

11. The method according to claim 1, wherein when the driving schedule exceeds a predefined penalty threshold, the method further comprises:
generating an alternative target path for the vehicle; and
including the alternative target path in the instructions.

12. A method of controlling a battery electric mining vehicle in a mine, the method comprising: generating a driving schedule, wherein generating the driving schedule comprises:
obtaining a current state of charge of the vehicle;
obtaining a target path of the vehicle, the target path comprising:
a charging section provided in a section of the target path, the charging section having a charging infrastructure configured to provide a charging power to the vehicle; and
a road section suitable for the vehicle to regenerate electrical energy;
based on target path data and the current state of charge of the vehicle, generating the driving schedule comprising instructions to control a movement of the vehicle along the target path, wherein:
generating the driving schedule comprises optimizing the driving schedule according to penalties, and
the penalties comprise a penalty term indicative of an amount of energy wasted when the vehicle travels along the road section; and
driving the vehicle according to the driving schedule.

13. A scheduling system for generating a driving schedule for a battery electric mining vehicle, the scheduling system comprising:
a communication device configured to receive vehicle parameters indicative of a current state of charge of the vehicle; and
a modeling engine,
wherein the scheduling system is configured to obtain a target path of the vehicle, the target path comprising:
a charging section suitable for providing a charging power to the vehicle; and
a road section configured to regenerate electrical energy with the vehicle; wherein the modeling engine is configured to, based on target path data and vehicle parameters, generate the driving schedule comprising instructions to control a movement of the vehicle along the target path, wherein:
to generate the driving schedule, the modeling engine is configured to optimize the driving schedule according to penalties, and
the penalties comprise a penalty term indicative of an amount of energy wasted when the vehicle travels along the road section.

14. The scheduling system according to claim 13, wherein the scheduling system is comprised within an industrial site.

15. The scheduling system according to claim 13, wherein the battery electric mining vehicle is a mine truck.

16. The scheduling system according to claim 13, wherein the scheduling system is comprised within a mine.

17. The method according to claim 2, wherein:
optimizing the driving schedule comprises defining a target charge of the vehicle when exiting the charging section,
the target charge is a charge of the vehicle above a lower limit defined by an energy demand of the vehicle traveling along the target path after leaving the charging section and before entering the road section, and
the instructions cause the vehicle to remain within the charging section until the target state of charge is reached.

18. The method according to claim 2, wherein the penalties comprise:
a penalty term indicative of production constraints; and/or
a penalty term indicative of production targets.

19. The method according to claim 3, wherein the target path data include one or more of:
a target path layout;
a power availability along a section of the target path; and/or
a power demand along a section of the target path.

20. The method according to claim 3, further comprising:
obtaining vehicle parameters; and
generating the driving schedule based on the vehicle parameters, wherein the vehicle parameters include one or more of:
static vehicle parameters;
dynamic vehicle parameters;
vehicle constraints; and/or
schedule constraints.
